(19) United States
(12) Patent Application Publication
(10) Pub. No.: US 2009/0006109 A1
(43) Pub. Date: Jan. 1, 2009

(54) Rights Engine Including Event Logs

(75) Inventors: Ronald Martinez, San Francisco, CA (US); Chris Kalaboukis, Los Gatos, CA (US); Christopher Higgins, Portland, OR (US)

Correspondence Address: BAKER BOTTS L.L.P., 2001 ROSS AVENUE, 6TH FLOOR, DALLAS, TX, 75201, US

(73) Assignee: Yahoo! Inc., Sunnyvale, CA (US)

(21) Appl. No.: 11/770,096

(22) Filed: Jun. 28, 2007

(51) Int. Cl. G06Q 10/00; G06F 17/30; G06F 17/40

(52) U.S. Cl. 705/1; 705/400

(57) ABSTRACT

A location indicator indicative of a network address where a content item is located or a content item can be received from a rights holder. An indication of access rights, in a computer-readable, canonicalized format, to be associated with the content item is received from the rights holder. The content item or the location indicator is stored in association with the indication of access rights. A searchable repository can be provided to the content consumer. The searchable repository can be utilized by the content consumer to access the content item according to search parameters that comprise the indication of access rights associated with the content item. Transaction and content consumption events may be tracked to facilitate various functions, such as dynamic pricing models, access rights enforcement, and revenue tracking.

### BACKGROUND

1. Field

This disclosure relates to rights management, system, and in particular, to a rights engine for receiving and distributing rights associated to content items.

2. General Background

Business practices and information infrastructure relating to handling of rights, particularly media rights, are outdated, and constitute an impediment to business and commerce for all participants. Conventional methods are based upon a hierarchical manufacturing model. In that model, rights holders are at the top of the hierarchy, and create and also obtain rights in content items. The content items are licensed through established channels to large content consumers (e.g. distributors and retailers) using individually crafted and negotiated licenses. For small content consumers (e.g. individual users), however, associated rights agreements are generally one-size-fits-all agreements that limit the small content consumer to use on specified devices and in specified territories.

Current systems do not provide a scalable infrastructure that meets the requirements of contemporary and emerging rights creation and usage. This results in lost economic opportunity, customer satisfaction, and cultural enrichment. While content consumers have circumvented legacy rights processes (much as the Internet itself is designed to route information traffic around physical disasters) only a well-formed, contemporary, and extensible rights infrastructure can eliminate the underlying problem.

### SUMMARY

A location indicator indicative of a network address where a content item is located or a content item can be received from a rights holder. An indication of access rights, in a computer-readable, canonicalized format, to be associated with the content item is received from the rights holder. The content item or the location indicator is stored in association with the indication of access rights. A searchable repository can be provided to the content consumer. The searchable repository can be utilized by the content consumer to access the content item according to search parameters that comprise the indication of access rights associated with the content item. Transaction and content consumption events may be tracked to facilitate various functions, such as dynamic pricing models, access rights enforcement, and revenue tracking.

In one aspect, receiving the indication of the access rights includes receiving a license to use or to perform the content item. In another aspect, indication of indication of access rights can comprises an indication of a limited period of access. In another aspect the indication of access rights comprises an indication of a geographical limitation. In yet another aspect, the indication of access rights comprises an indication of a rendering device limitation.

In another aspect, the content, item can be a literary work, an intellectual property right, an electronic music file, or an electronic video file. In a further aspect, the content item can be stored in a content database.

In another aspect, there is a method of providing content to content consumers. Data indicative of a bundle of rights can be received from content consumers. An indication to associate the bundle of rights with a content item that has been previously submitted by the rights holder is received from the rights holder. The bundle of rights is associated to the content item previously submitted by the rights holder. The content item is provided to content consumers such that the content consumers have access rights to the content item according to rights provided by the bundle of rights.

In one aspect, the content item can be provided as part of a searchable repository via which the consumer can access the content item according search parameters that match the bundle of rights.

The content item can be displayed as a preview user interface that permits a content consumer to preview the content item. The preview user interface can be for example, an image, a video clip, a screenshot, among others. The bundle of rights can farther be associated with one or more items. In a further aspect, editing input that changes the bundle of rights into a modified bundle of rights can be received from a rights holder. The modified bundle of rights can then be applied to another content item.

### DRAWINGS

The features and objects of alternate embodiments of the present disclosure will become more apparent with reference to the following description taken in conjunction with the accompanying drawings of various examples wherein like reference numerals denote like elements and in which:

FIGS. 1A-1B depict a component diagram of a system for submitting and retrieving content rights according to one embodiment.

FIG. 2 depicts a component diagram of a computing device according to one embodiment.

FIG. 3 depicts a flow diagram of a process for submitting content rights to a rights provider according to one embodiment.

FIG. 4 depicts an example of a user interface for providing a rights model selection to a rights holder according to one embodiment.

FIG. 5 depicts an example of a user interface for entering agreement information related to rights to a content item according to one embodiment.

FIG. 6 depicts an example of a user interface for entering a content location according to one embodiment.

FIG. 7 depicts an example of a user interface for entering a period of time related to rights to a content item according to one embodiment.

FIG. 8 depicts an example of a user interface for entering fee payment information related to rights to a content item according to one embodiment.

FIG. 9 depicts an example of a user interlace for entering permitted territories information related to rights to a content item according to one embodiment.

FIG. 10 depicts an example of a user interface for entering permitted devices information related to rights to a content item according to one embodiment.

FIG. 11 depicts an example of a user interface for selecting whether a rights configuration is to be saved according to one embodiment.

FIG. 12 depicts a flow diagram of a process for searching content items and associated rights according to one embodiment.

FIG. 13 depicts an example of a user interface for searching content items and associated rights according to one embodiment.

FIG. 14 is a flow diagram illustrating an example method directing to access rights acquisition.

FIG. 15 is a flow diagram illustrating an example method directed to responding to requests for content items.

FIG. 16 is a schematic diagram setting forth an example message flow, according to one possible implementation of the invention.

FIG. 17 is a flow diagram illustrating another example method directed to responding to requests for content items.

FIG. 18 is a flow diagram illustrating another example method directing to access rights acquisition.

FIG. 19 is a flow diagram illustrating another example method directing to access rights acquisition.

FIG. 20 is a schematic diagram setting forth an example message flow, according to one possible implementation of the invention.

### DETAILED DESCRIPTION

Methods and systems of providing a normalized, searchable rights engine and repositories are disclosed herein. The rights engine can permit registration of rights under multiple rights regimes for any content item. As used herein a content item refers to any media, software, service, tool, or concept that can be distributed to a consumer based on an assigned right. Likewise, as used herein, rights can encompass a set of permissions, freedoms, restrictions, and/or obligations to access and/or use a content item.

In an embodiment, one or more rights can be registered in association with a content item in order to provide access to content consumers. Large traditional rights holder companies as well as end users, affiliates, distributors, business units within a given company, may all register rights associated to any content item with the rights engine. Additionally, the same rights holder that registers a right and associated content can become a content consumer who can access the content items under varying levels of authority. All rights may be searched or tagged, either by providers or consumers. Advertisements may also be associated with rights, as well as a variety of commerce models, including pay per item, pay per view, subscription, and so on.

In one embodiment, the rights engine system described herein permits the networked, digital medium rights creation, distribution, and consumption to follow a cyclical course. A rights cycle starts when the rights are created, acquired, and/or licensed. Eights creators can then become consumers, which in turn can create new content items. As such, any consumer receiving rights-governed content can re-use the content according to the rights associated with such content. For example, the consumer may reuse the content on a blog, podcast, video, or personal site, consistent with rights embodied in the rights engine.

In another embodiment, the rights engine can permit rights holders to determine which devices can render the content items. For example, media is consumed on an ever-expanding set of devices. Thus, digital video, for instance, may be experienced on a television, a computer, and then on a mobile phone or portable media player. A rights holder can pre-select which of these devices are permitted to render the digital video. Thereafter, a provider of the media, itself may provide alternative formatting consistent with the playback requirements of the various player devices.

Media portions are also fully supported, enabling recombination of various content items into a new content item which may in turn be provided to the rights engine with new associated rights.

As such, the system and method disclosed herein, supports remixed content, for both content originated for remix purposes, and for that which has been repurposed. For example, a film studio could digitize video clips from a film library, and push the video clips into the rights engine. The rights holder can require a fee when the video clips are used in another work. Alternatively, the rights holder can make the clips available without charge as a marketing tool. Keywords and tags associated with such remixable content may be found and ads may be delivered alongside the content when the content is viewed or experience online. Thus, consumers can find and incorporate remixable media into new composite works using video or audio remixers, or podcast creators, websites, or other media forms. Remixed portions of content items can include identifiers used, to reference information about each content portion, including payment, keywords, rights holder information, other content related via tags, and so on.

Accordingly, the system and method disclosed herein allows for easy and secure access to content items. For example, rather than entering into complex negotiations to enable a large Internet service provider or retailer to distribute and resell video or audio content, a rights holder can simply submit the relevant content to the rights engine on his own initiative, setting terms and payment requirements desired by the rights holder. A right provider that manages the rights engine can then make the submitted content item available exactly as offered by the rights holder. When a content item is sold, the rights provider remits payment to the rights holder according to pre-established payment information for the rights holder. In other words, complete retail offerings for varied territories, devices, and content types can be implemented automatically with little or no human inventory management or agreement constructions. The agreements are provided according to stored agreements previously submitted by the rights holder. Moreover, the same mechanisms are available for large rights-producing companies as well as small companies and individual consumers. Each can push rights and references to associated content to the rights engine.

The rights engine described herein may be used in a variety of contexts. In one implementation, the interfaces to the rights engine are essentially private or internal to an enterprise. For example, the rights engine may be used as an internal system relative to a given enterprise. For example, a department of an enterprise that creates or acquires rights to digital content may access the rights engine to register content objects for use by other departments within the enterprise. For example, a content in-licensing department may acquire rights, such as license or use rights, to a set of photographic images. A user within the in-licensing department may register the newly in-licensed content objects by accessing the rights engine and inputting attributes of the in-licensed content objects and one or more access rights attributes characterizing the terms of use, restrictions, payment terms and the like. A consuming user within the same enterprise (such as a web development department) may then use the rights engine to search for digital content objects having access rights attributes that are suitable for some contemplated use.

In other implementations, one or more of the interfaces to the rights engine, relative to a given enterprise, may also be external interfaces accessible to partners or the general public. For example, in one implementation, the content provider interface of the rights engine may be publicly accessible to allow external users to register content items for use by the enterprise under the terms specified by the access rights attributes. In other implementations, the content searching and consumption interfaces may be publicly accessible, as opposed to the content provider interfaces. In yet other implementations, the content provider and content consumer interfaces may be publicly accessible to create a content rights marketplace.

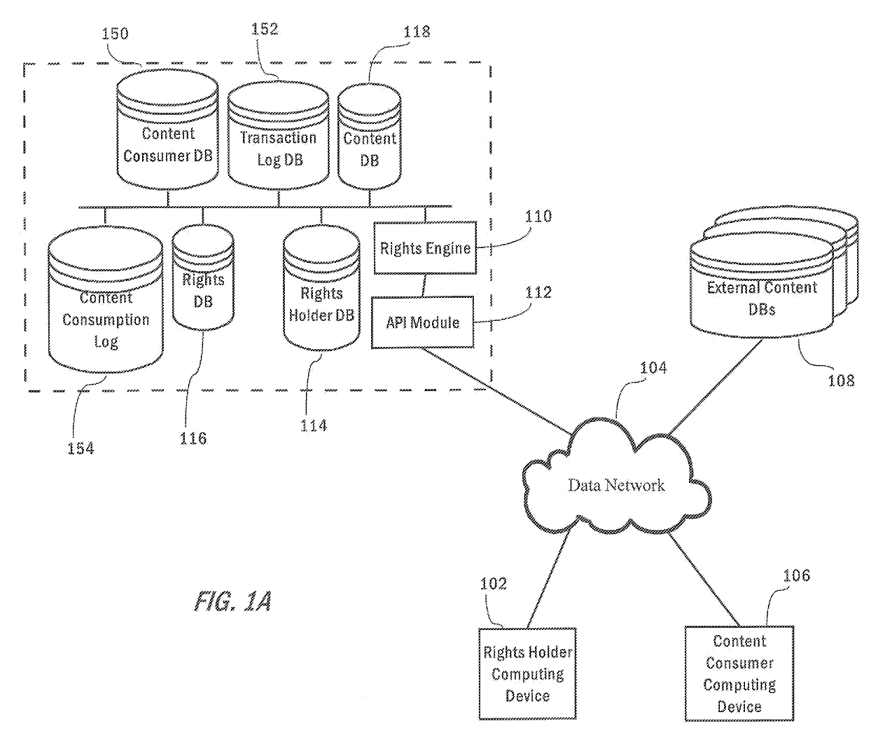

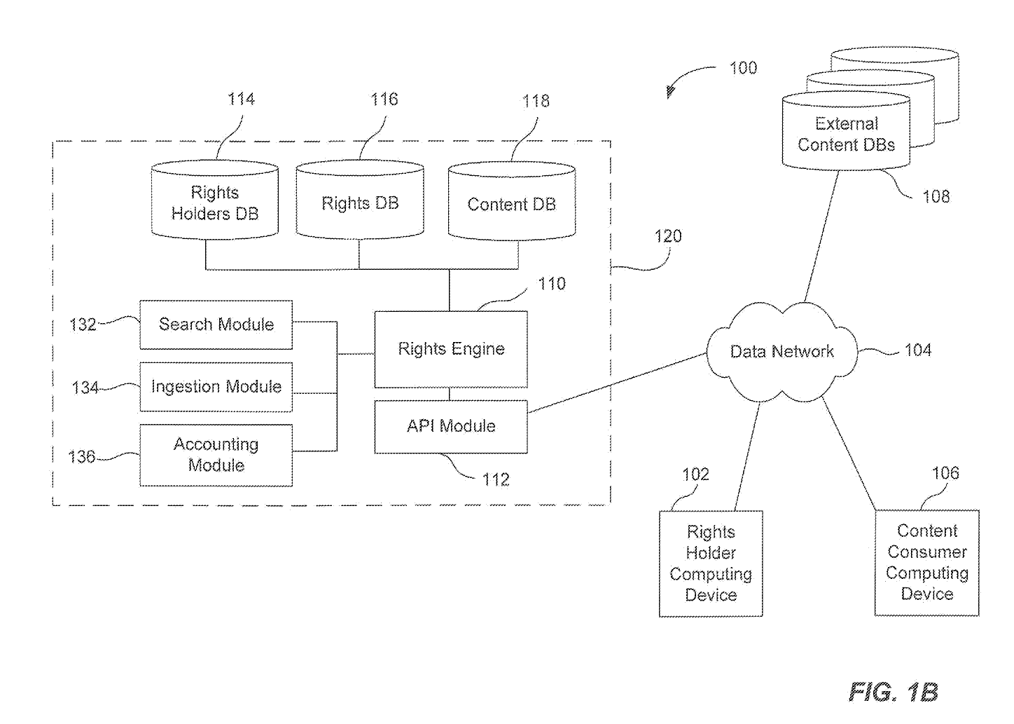

FIG. 1A depicts a component diagram of a system for submitting and retrieving content rights according to one embodiment. A rights provider 120 permits the creation of rights as well as the submission of rights to a rights engine 110. In addition, the rights provider 120 can also permit the consumption of rights associated with content items. In one embodiment, the rights provider 120 can be a business entity that has an associated computer infrastructure that permits the storing of content rights by content rights holders as well as the consumption of content rights from content consumers. As such, the rights provider 120 can provide an API module 112 to interface via a data network 104 with rights holders and content consumers. For example, a rights holder can communicate via the data network 104 utilizing a rights holder computing device 102. The rights holder computing device 102 can be configured to interact with functionality of the rights engine 110 via a set of APIs (application program interfaces) that can be invoked by the rights holder computing device 102. As such, a rights holder can utilize one or more APIs provided by the API module 112 to submit content items or location of content items as well as associated rights corresponding to the content items. In one example, the APIs provided at the API module 112 can include, for example, operations such as create, read, update and delete that can be applied to one or more content items and/or associated rights to the content items.

In one embodiment, a rights holder that submits content item information and content rights to the rights engine 112 can be a subscribed rights holder that has an associated rights holder identifier. As such, the rights holder identifier and other information related to the rights holder can be, for example, stored at a repository such as rights holder database 114. Table A shows an exemplary rights holder record with corresponding fields and a description of the fields. The rights holder record can for example include information related to the rights holder such as the name, contact information, rights holder identifier, payment information, website address, keywords associated with the content, among others.

TABLE A
Rights Holder

| Field | Description |
|---|---|
| rightsholder_name | name of rights holder |
| contact_name | contact name |
| contact_email | email address of contact |
| contact_phone | phone number of contact |
| physical_address | address_of_rightsholder |
| assigned_ID | a sixteen character ID assigned by system |
| pay_to_institution | bank or other institution name |
| routing_number | bank routing number |
| bank_account_number | bank account number |
| web_address | URL of rights holder website |
| rightsholder_tags | tags in string form, created by r.h. or others |
| keywords | descriptive keywords provided by rights holder |

A rights provider 120 can further include as part of its computer infrastructure a rights database 116 and a content database 118. The rights database 116 can include one or more records indicative of rights information such as license agreements, patent documents, trademark registration, copyright registrations, etc. stored in association with content items. Furthermore, the content database 118 can store one or more content items or content items addresses as received from a rights holder who has submitted a content item. Therefore, in one example, a rights holder can for example submit simply the address or location of a content item such as a media file or a software application or a service. In another example, a rights holder can provide the actual content item and upload the content item to the content database 118. In order to do this, the rights holder would connect via the rights holder computing device 102 to the rights engine 112 utilizing one or more APIs via the API module 112. The rights holder can then, for example, submit a video clip that is uploaded to the content database 118. The rights holder's database 114, the rights database 118 and the content database 118 as well as any data repositories utilized by the rights engine 110 can be locally and directly connected for interfacing with the rights engine 110, or can also be remotely connected via a data network such as data network 104. Although the latter example is not illustrated in FIG. 1, a data network such as for example the Internet can be utilized to access remote databases via the Internet.

In a further embodiment, an external content database 108 can be accessible to the rights engine 110. Thus, for example, when a rights holder provides a location for content items, the rights engine 110 can be configured to retrieve the content item information from the external content database 108. In one example, the rights engine 110 can be configured to simply store a reference address at the content database 118 which references the content items stored in the external content database 108. In another example, the rights engine 110 can be configured to copy the content items stored in the external content database 108 into the content database 118. The system 100 can further interact with a content consumer computing device 106 that is utilized by a content consumer to access the content items as well as the rights associated with the content items. The content consumer computing device 108 can also be configured with logic to utilize the APIs provided by the rights provider 120 in order to request one or more content items according to the associated rights of the content items. Content consumers can include for example end users, individuals, large business entities such as production companies, film makers, etc. In addition, the content consumer can for example be business units associated to the rights provider 120. In yet another example, the content consumers can be partners or affiliates of the rights provider 120. As previously mentioned, content consumers can further utilize content items and associated rights to further manipulate, edit, mix or change content which is then recycled and fed again to the rights engine 110 as a new content item with new associated rights. In this manner, a content consumer becomes a rights holder.

FIG. 1B depicts a component diagram of a system for ingesting content items and rights, searching content items and rights, and accounting, according to one embodiment. In one embodiment, the API module 112 can farther be coupled to one or more logic modules to perform necessary operations for the submission, retrieval and recycling of content items and associated rights. A search module 132 can be provided with logic in order to perform searches of specific content items that a content consumer may search for, as well as specific rights that a content consumer would like to license or obtain. For example, a content consumer can submit a query to the search module 132 for searching rock music from the year 2004 with public domain rights. Other examples exist of queries that can be utilized to search content items via the rights engine 110. Search parameters can for example include rights holder's names, rights holder's contact information, form of payment, licensing fee, type of content item, size of content item, quality of content item, etc.

In another embodiment, an ingestion module 134 can be configured to receive content items as well as associated rights, defined by one or more access rights attributes, from a rights holder through the data network 104. In one embodiment, the ingestion module 134 is configured to receive at least one content item or location of the content item and one or more associated rights attributes. In another embodiment, the ingestion module 134 is configured to receive a bulk feed, for example, a rights holder may have hundreds of songs that a rights holder would like to register at the rights engine 112, and assign associated rights. In order to do this, a rights holder can submit the content item information in bulk in order to facilitate the process. In one example, the rights holder may provide one indication of the type of bundle of rights that needs to be associated with the bulk of content and subsequently, the bulk of content can be uploaded, or a location where the bulk of content exists, can be provided to the rights engine 110.

An accounting module 136 can also be included as part of the rights provider 120 infrastructure. The accounting module 136 can be configured to receive payment from a content consumer and allocate the payment to the correct rights holder. To do this, the accounting module 136 can be configured to access the rights holders database 114 as well as the rights database 116 wherein license fee information associated with specific rights or a content item is stored. As such, the accounting module 136 can correlate license fees required by rights holders and ensure that payment is provided for content that has been provided at a desired cost.

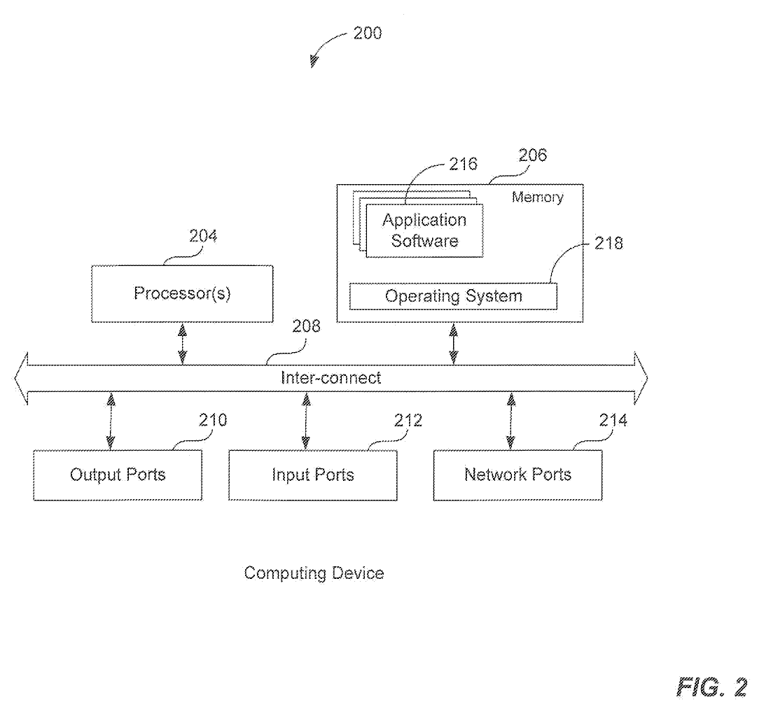

FIG. 2 depicts a component diagram of a computing device according to one embodiment. The computing device 200 can be utilized to implement one or more computing devices, computer processes, or software modules described herein. In one example, the computing device 200 can be utilized to process calculations, execute instructions, receive and transmit digital, signals, as required by the computing device 200. In one example, the user computing device can be utilized to process calculations, execute instructions, receive and transmit digital signals, receive and transmit content data and associated rights, as required by the rights engine and API modules.

The computing device 200 can be any general or special purpose computer now known or to become known capable of performing the steps and/or performing the functions described herein, either in software, hardware, firmware, or a combination thereof.

In an example, computing device 200 includes an inter-connect 208 (e.g., bus and system core logic), which interconnects a microprocessor(s) 204 and memory 206. The inter-connect 208 interconnects the microprocessor's) 204 and the memory 206 together. Furthermore, the interconnect 208 interconnects the microprocessor 204 and the memory 206 to peripheral devices such input ports 212 and output ports 210. Input ports 212 and output ports 210 can communicate with I/O devices such as mice, keyboards, modems, network interfaces, printers, scanners, video cameras and other devices. In addition, the output port 210 can further communicate with the display 104.

Furthermore, the interconnect 208 may include one or more buses connected to one another through various bridges, controllers and/or adapters. In one embodiment, input ports 212 and output ports 210 can include a USB (Universal Serial Bus) adapter for controlling USB peripherals, and/or an IEEE-1394 bus adapter for controlling IEEE-1394 peripherals. The inter-connect 208 can also include a network connection 214.

The memory 206 may include ROM (Read Only Memory), and volatile RAM (Random Access Memory) and non-volatile memory, such as hard drive, flash memory, etc. Volatile RAM is typically implemented as dynamic RAM (DRAM), which requires power continually in order to refresh or maintain the data in the memory. Non-volatile memory is typically a magnetic hard drive, flash memory, a magnetic optical drive, or an optical, drive (e.g., a DVD RAM), or other type of memory system which maintains data even after power is removed from the system. The non-volatile memory may also be a random access memory.

The memory 206 can be a local device coupled directly to the rest of the components in the data processing system. A non-volatile memory that is remote from the system, such as a network storage device coupled to the data processing system through a network interlace such as a modem or Ethernet interface, can also be used. The instructions to control the arrangement of a file structure may be stored in memory 208 or obtained through input ports 212 and output ports 210.

In general, routines executed to implement one or more embodiments may be implemented as part of an operating system 218 or firmware or hardware, or a specific application, component, program, object, module or sequence of instructions referred to as application software 216. The application software 216 typically can comprises one or more instruction sets that can be executed by the microprocessor 204 to perform operations necessary to execute elements involving the various aspects of the methods and systems as described herein. For example, the application software 216 can include video decoding, rendering and manipulation logic.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g. Compact Disk Read-Only Memory (CD ROMS), Digital Versatile Disks, (DVDs), etc.), among others. The instructions may be embodied in digital and analog communication links for electrical, optical, acoustical or other forms of propagated signals, such as carrier waves, infrared signals, digital signals, etc.

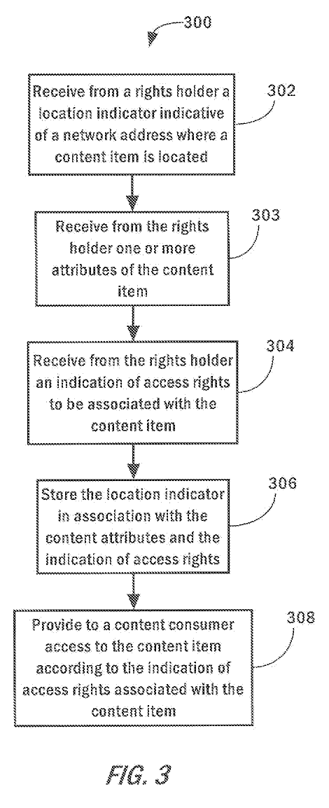

FIG. 3 depicts a flow diagram of a process for submitting content rights to a rights provider according to one embodiment. At process block 302, a location indicator that is indicative of a network address where the content item is located is received from a rights holder. In one example, the location indicator can be a URL (universal resource locator) address or URI (universal resource identifier). In another embodiment, the location indicator can include, for example, an IP (internet protocol) address. Process 300 continues at process block 303. At process block 303, one or more attributes characterizing or relating to the content are received from the rights holder. These attributes may be keywords, titles, summary information, descriptions, media-related attributes, such as duration, physical dimensions, compatibility requirements, among others. Furthermore, the rights holder may further specify a relation between the content item and other pre-existing content items. For example, the rights holder may indicate that the subject content item is a derivative work of another content item (such as a cover version of a song, a mash up including an underlying code module, etc.).

At process block 304, an indication of access rights to be associated with the content item is received from the rights holder. Access rights can, for example, be sharing rights, publication rights, distribution rights, indications of what territory is covered by the access right, an indication of what devices are covered by access right, etc. Process 300 continues at process block 306.

At process block 306, the location indicator is stored in association with the indication of access rights. As such, the location indicator can be stored with a reference to the access rights associated to the content item corresponding to the location indicator. Process 300 continues at process block 308. In a particular implementation, if the content item is identified as being based on, or a derivative work of, another content item, rights provider 120 may verify that the submitted content item complies with the access rights of the other content items. A compliance error may trigger a notification to the rights holder of the instant and underlying content items, a warning message to the instant rights holder, and/or other processes.

At process block 308, content consumers are provided access to the content item according to the location indicator and the indication of access rights associated with a content item. As such, either the content item is provided to the content, consumer or an address to the content item is provided to the content consumer.

### Rights and Content Submission

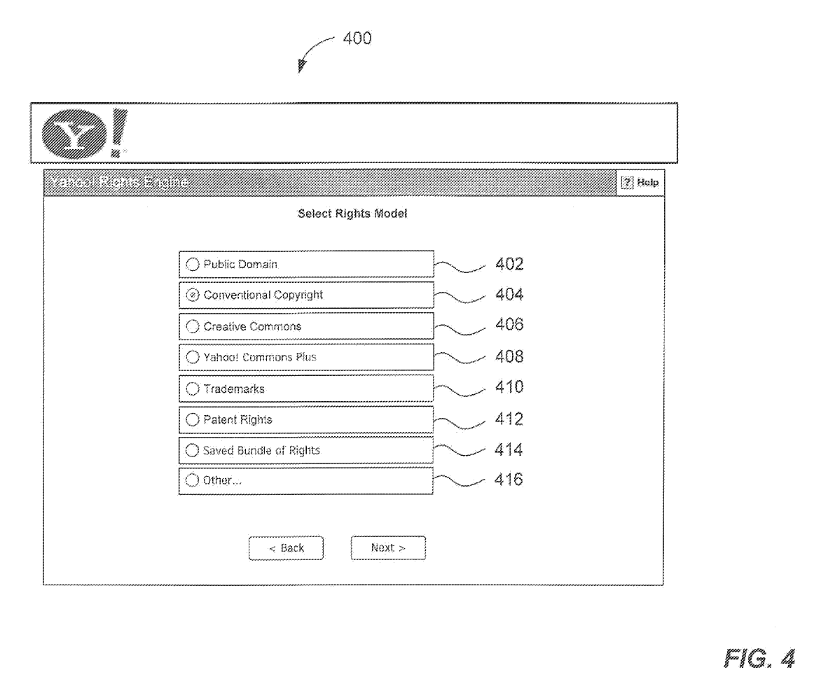

As mentioned above, one or more types of rights can be assigned to a content item to be provided to a content consumer. Thus, a rights holder can utilize one or more interfaces to enter rights and content information to the rights engine 110. The user interfaces provided in FIGS. 4 through 10 are exemplary user interlaces only. Therefore, other processes and user interfaces can be utilized by a rights holder to register and submit a content item as well as configure one more rights associated to the content item. For example, a rights holder can submit a source code script that includes calls to one or more APIs.

Furthermore, rights holders can be users that are subscribed to their rights provider 120 and have a user identifier. In another embodiment, a rights holder can be anonymous users.

FIG. 4 depicts an example of a user interface for providing a rights model selection to a rights holder according to one embodiment. Interface 400 provides a list of rights models that can be selected by a rights holder. The rights model selected by the rights holder can be supplied in relation to the content item. Thus, for example, if the content item is a trademark, the rights model utilized as applied to the trademark can include a determination of a geographical location or area where the license is provided, fields for quality control, etc. In another example, if the content item is a digital video clip, the rights holder may want to utilize a public domain rights model or a conventional copyright rights model. As one skilled in the art will appreciate, the rights model selected by the rights holder can vary according to the content item and/or can be applied freely by the rights holder.

In one example, a public domain selection 402 can be provided to a rights holder. The public domain selection 402 can permit a rights holder to indicate the parameters and conditions under which a specific content item is provided as part of a public domain. For example, the rights holder may require that recognition of the rights holder and creator's name be included as part of the display, distribution or performance of a specific media item. As such, if a rights holder selects the public domain selection 402, further user interface screens may be presented to the rights holder in order to enter information related to public domain rights associated with the submitted content item. The public domain information related to the content item can be stored as a record in the rights database 116. Table B depicts an exemplary data structure corresponding to a record for a public domain rights entry. Information related to the content item such as name, author, description, type and format can be stored as part of the public domain entry. In addition, the location of the associated content item, can be stored in the form of a URL, URI, or any other address of reference. Finally, tags and keywords can also be entered as part of the public domain entry in order to make the content item related to the public domain entry searchable.

TABLE B
Public Domain

| Field | Description |
|---|---|
| item_name | name, a string |
| item_author | name, a string |
| item_description | description, 256 characters |
| item_type | video \| audio \| image \| text \| interactive |
| item_format | mpeg-1 \| mpeg-2 \| jpeg \| gif \| quicktime \| text \| |
| | etc. |
| item_assigned_ID | system-assigned unique ID |
| rightsholder | system-assigned unique ID |
| item_location | URL of item |
| item_group | name of semantic grouping item belongs to |
| rightsholder_tags | tags in string form, created by r.h. or others |
| keywords | descriptive keywords provided by rights holder |

In another example, a conventional copyright selection 404 can be provided as part of user interface 400 to a rights holder. A rights holder may select a conventional copyright selection 404 if the rights holder wants to register or submit a content item and in addition, provide a traditional copyright right associated to the content item. An associated rights entry can be stored in the rights database 116 according to one or more configurations. In one embodiment, one configuration can include the content item information such as name, author, description, type and format of the content item. In addition, information related to the type of agreement required, such as distribution and user wholesale, etc. can also be provided as one of the fields in the configuration data structure. Furthermore, the location of signed agreements and agreement documents related to the conventional copyright can also be included as part of the rights entry recorded and stored at the rights database 116. Information related to the period of the license, as well as fee related information such as amounts, currency, percentage of retail sales, etc. can be also part of the rights entry for a conventional copyright. Other information such as the territory where a license can be provided, devices that may be permitted to render the content item and any other information that can be used to limit or extend the associated rights. Table C below is an exemplary table that illustrates a data structure corresponding to an entry for a conventional copyright.

TABLE C
Conventional Copyright

| Field | Description |
|---|---|
| item_name | name, a string |
| item_author | name, a string |
| item_description | description, 256 characters |
| item_type | video \| audio \| image \| text \| interactive |
| item_format | mpeg-1 \| mpeg-2 \| jpeg \| gif \| quicktime \| |
| | text \| etc. |
| rightsholder | system-assigned unique ID |
| agreement_type | distribution, end-user, affiliate, wholesaler, |
| | other |
| signed_agreement | URL of scanned agreement |
| final_agreement_unsigned | URL of word proc document |
| item_location | URL of item |
| item_group | name of semantic grouping item belongs to |
| license_start | a time |
| license_end | a time |
| fee_required? | yes or no |
| paid_by | end user \| distributor, other |
| fee-type | flat fee \| percentage \| pay-per-view \| |
| | subscription |
| percentage_of_retail | a percentage |
| flat_fee_amount | amount |
| currency | form of currency (e.g., USD, GBP, etc.) |
| territory | global \| list of territories |
| device | global \| list of devices |
| drm | none \| form of DRM |
| copyright_year | year of copyright created |
| item_tags | tags in string form, created by r.h. or others |
| keywords | descriptive keywords provided by rights |
| | holder |

A third party rights management scheme, such as for example creative commons selection 406 can also be included as part of the rights model list. For example, the creative commons selection 406 can be utilized by a rights holder who wants to provide access to his or her content items based on a creative commons scheme. As such, when the rights holder selects the creative commons selection 406, multiple user interfaces can be provided such that the rights holder can input the location of the content item as well as creative commons references as related to the content item. Table D below exemplifies a data structure for a creative commons entry that can be stored in the rights database 116. The creative commons entry can include item information such as name, author, subscription, type and format. In addition, creative commons information specific to the content item can also be included, such as the agreement type, etc. The jurisdiction (generic or specific), modifications (true, false, share alike), and commercial use (true, false). Furthermore, the content item location can also be provided and included in the creative commons entry in the form of a URL or any other location indicator.

TABLE D
Creative commons

| Field | Description |
|---|---|
| item_name | name, a string |
| item_author | name, a string |
| item_description | description, 256 characters |
| item_type | video \| audio \| image \| text \| interactive |
| item_format | mpeg-1 \| mpeg-2 \| jpeg \| gif \| quicktime \| text \| |
| | etc. |
| rightsholder | system-assigned unique ID |
| agreement_type | CC \| Sampling \| Sampling + \| Non-comm Smpl + |
| allow_commercial | true \| false |
| allow_modifications | true \| false \| share-alike |
| cc_jurisdiction | generic \| specific jurisdiction |
| item_location | URL of item |
| item_group | name of semantic grouping item belongs to |
| item_tags | tags in string form, created by r.h. or others |
| keywords | descriptive keywords provided by rights holder |

In another example, an alternate rights management, scheme, such as for example that referred to by the assignee of this application as Yahoo! Social Distribution Plus, as selection 408 can be provided to the rights holder to select a commons plus scheme wherein content items can be licensed exclusively or non-exclusively by payment of a fee. Thus, for example, the Yahoo! Social Distribution Plus data structure for an entry in the rights database 116 can include item information as well as creative commons information and preferences from the rights holder. In addition, the Yahoo! Social Distribution Plus entry can also include payment information, restrictions on duration, geographical scope, devices that can render the content item, etc. Table E below shows an exemplary data structure for a Yahoo! Social Distribution Plus entry.

TABLE E
Yahoo! Social Distribution Plus

| Field | Description |
|---|---|
| item_name | name, a string |
| item_author | name, a string |
| item_description | description, 256 characters |
| item_type | video \| audio \| image \| text \| interactive |
| item_format | mpeg-1 \| mpeg-2 \| jpeg \| gif \| quicktime \| text \| |
| | etc. |
| rightsholder | system-assigned unique ID |
| agreement_type | Sampling \| Sampling + \| Non-comm Smpl + |
| allow_commercial | true \| false |
| allow_modifications | true \| false \| share-alike |
| item_location | URL of item |
| item_group | name of semantic grouping item belongs to |
| license_start | a time |
| license_end | a time |
| fee_required? | yes \| no |
| paid_by | end user \| distributor, other |
| fee-type | flat fee \| percentage \| pay-per-view \| subscription |
| percentage_of_retail | a percentage |
| flat_fee_amount | amount |
| currency | form of currency (e.g., USD, GBP, etc.) |
| territory | global \| list of territories |
| device | global \| list of devices |
| item_tags | tags in string form, created by r.h. or others |
| keywords | descriptive keywords provided by rights holder |

In yet another example, a trademark selection 410 can be provided for a rights holder to select a specific rights model. In addition, a patent rights selection 412 can also be provided for a rights holder to select the appropriate rights model.

In one embodiment, rights granted by the rights holder can be contained as part of a bundle of rights. As such a rights holder can create one or more rights bundles and apply such rights bundles to content items. A bundle of rights can be generally a configuration of rights that establishes permissions, restrictions and obligations of a content consumer with respect to a content item. Pre-configured and saved bundles of rights can be stored in association with a rights holder. Accordingly, the rights holder can apply pre-saved bundles of rights to one or more content items.

As such, the rights holder can also be provided with a saved bundle of rights selection 414. The saved bundle of rights selection permits a rights holder to go back to a specific pre-selected and pre-configured bundle of rights that the rights holder had entered in the past. For example, the rights holder may have entered a rights model for a specific content item and further selected to save the configuration of rights in relation to that content item. Such configuration of rights can be applied at a later time, as a bundle of rights, to other content items that the rights holder may want to upload. Such pre-saved bundle of rights can be useful in cases where the rights holder continuously submits content items and content item information that the rights holder would like to have similar rights applied to.

In one example, the public domain rights model can be configured by a rights holder with modified rights that can be saved as a new bundle of rights. In another example, the conventional copyright rights model can be configured by a rights holder with modified rights that can be saved as a new bundle of rights. In another example, the creative commons rights model can be configured by a rights holder with modified rights that can be saved as a new bundle of rights. In another example, the trademark rights model can be configured by a rights holder with modified rights that can be saved as a new bundle of rights. In another example, the patent rights model can be configured by a rights holder with modified rights that can be saved as a new bundle of rights.

In yet another example, the previously saved bundle of rights can also be configured by the rights holder with modified rights that can be saved as a new bundle of rights. As such, the saved bundle of rights selection 414 can be configured with new terms, obligations, restrictions so as to change the saved bundle of rights, and effectively create a new configuration of rights that can be saved as a new bundle of rights.

In addition, a customized configuration of rights can also be created and later saved as a bundle of rights. In one embodiment, a selection 416 can be provided for a rights holder to select a customized selection of rights that allows a rights holder to establish territorial scope, fee payments, rendering devices scope, exclusivity, etc. In addition, any other types of rights definitions can be associated with the customized configuration of rights. In other words, a rights model can be configured with a new set of restrictions, permission, and obligations that are created by the rights holder and that are not necessarily a conventional granting of rights. For example, a rights holder may create a bundle of rights that provides public domain rights to a song, under the condition that every time the song is performed in public, the name of the band is announced at the beginning and at the end of the song. One of ordinary skill in the art will recognize, from the teachings herein, that there are various ways of configuring a rights model and that the examples provided herein are for illustration purposes only.

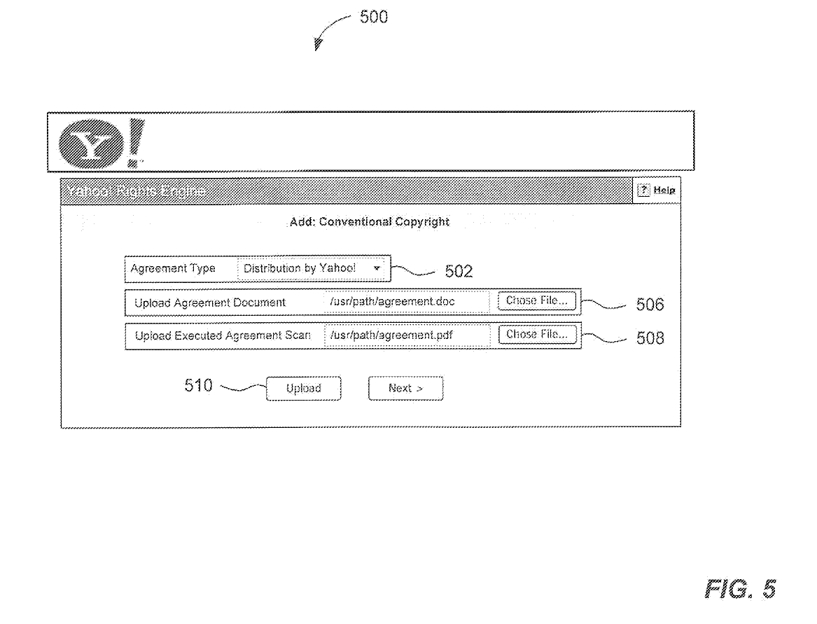

FIG. 5 depicts an example of a user interface for entering agreement information related to rights to a content item according to one embodiment. The rights holder can create rights that can be used for distribution of associated content items by a company or companies, or any other service provider, as indicated by the rights holder. As such, the rights holder can indicate the agreement type at a drop-down menu 502. The agreement type can for example be a distribution agreement by the rights provider 120, a distribution agreement by a third party, etc.

User interface 500 can further be utilized by a rights holder to upload and receive agreements created using traditional methods as memorialized by paper contracts. As such, agreements, licenses and any other forms or documents that, for example, the rights holder has signed, can be uploaded in connection with rights associated to a specific content item. In one embodiment, a choose file button 506 can be provided to upload a first type of format for an agreement to be uploaded. The format can be, for example, in word processing format. In addition, in a choose file button 508 to be provided for a rights holder to upload an agreement that is in post-script format such as a PDF file. Once the rights holder selects the location of a word processing file or a post-script file, the rights holder can select an upload button 510 in order to transmit the agreements in digital form to the rights engine 110. The rights engine 110 can then store the agreements at the rights database 116 in association with the content item.

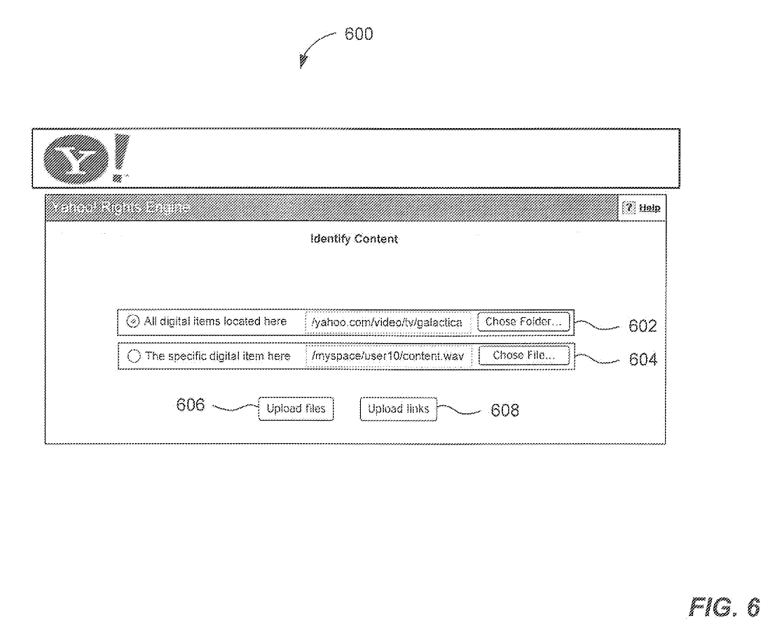

FIG. 6 depicts an example of a user interface for entering a content location according to one embodiment. The rights holder can enter the location of the content items at user interface 600. In one embodiment, the rights holder can enter a location where multiple content items are located. For instance, the rights holder can enter the network location in field 602. In another embodiment, the rights holder may select to enter one specific content item that is located in a network location. For example, the rights holder may enter, at field 604, a network address or location indicator of a specific file. Furthermore, the rights holder may choose to upload the content items to the content database 118 or to simply upload a link to the content items. In one example, a button 606 can be utilized to upload the digital files corresponding to the content items. In another example, the rights holder must select button 602 to simply upload that reference the address of the content items.

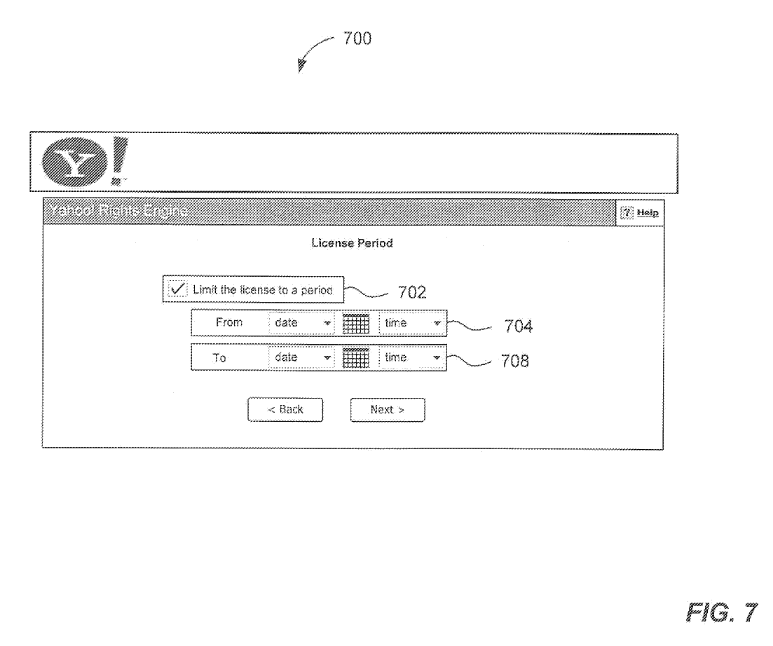

FIG. 7 depicts an example of a user interface for entering a period of time related to rights to a content item according to one embodiment. The user interface 700 can be provided for a rights holder who wishes to limit the distribution of a content item based on a license that lasts a specific time period. As such, the rights holder may utilize checkbox 702 to indicate that a rights holder wants to limit the license for a specific period of time. For example, user interface 704 includes a check box, a date field and time drop-down menus that will permit a rights holder to indicate a time and a date in which the license period will start. In addition, a user interface 708 can include a checkbox to indicate that there is an ending period as well as a text box for entering the date and drop down menus for entering a time. As can be appreciated by one skilled in the art, a rights holder may choose not to limit a license to a specific period. In another example, the rights holder may choose to limit the license to a specific period of time that starts at a selected date and time and ends at a selected date and time. In another example, the rights holder may select to start a license at a selected time and date, and may further choose not to have an ending date for the license period. In another example, the rights holder may simply choose an ending date, in which case the starting date would be the date in which the rights holder completes the submission of the content item and rights.

In one embodiment, the expiration of the rights provided to the consumer can be enforced using one or more known methodologies. For example, the content item can be accompanied by an encrypted key that ceases to grant access to the content item on pre-determined date. For example, a rendering device would only render the content item according to the provided key associated with the content item. In other embodiments, any digital rights management methodology can be utilized for content items. In yet another embodiment, a notice or message provided to the content consumer can serve as the enforcement mechanism. In yet another embodiment, content items such as intellectual property rights can have associated legal rights that are enforced as using regular vehicles for enforcing intellectual property rights (e.g. courts of law, etc).

Furthermore, in another embodiment, rights granted to content consumers are provided such that the content consumers have an incentive to maintain the integrity of the granted rights and the associated content. One skilled in the art will recognize that various mechanisms of rights delivery can be utilized.

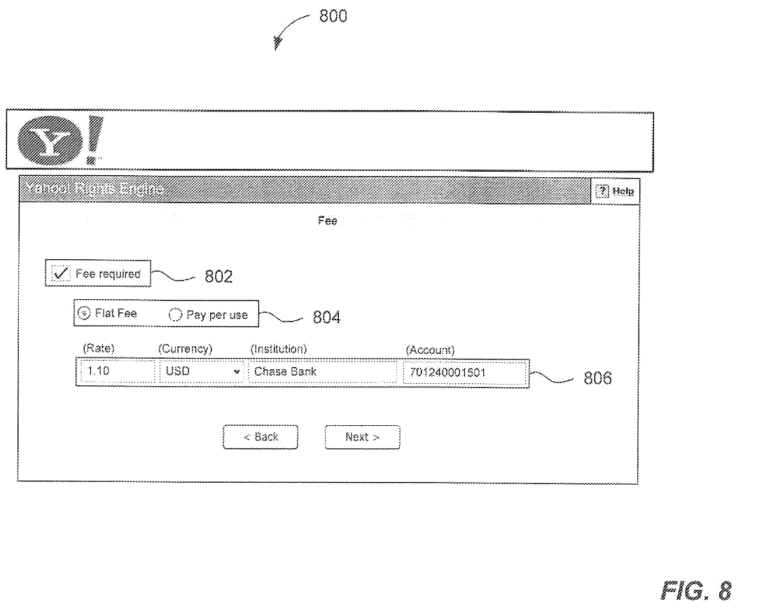

FIG. 8 depicts an example of a user interface for entering fee payment information related to rights to a content item according to one embodiment. In one example, the rights holder can indicate whether a fee is required when the consumer requests the content item. To that end, a check box 802 can be provided for the rights holder to check. Furthermore, the rights holder can also be provided with the radio button selection 804 that permits the rights holder to either select a flat fee or a pay-per-use scheme. Of course, a flat, fee would allow a consumer to pay a one-time fee and enjoy the content item and utilize a content item as many times as the consumer would like to. A pay-per-use scheme would require that the consumer make a payment every time a consumer used the content item. Furthermore, a user interface 806 can be provided to the rights holder in order to enter financial institution information as well as rates. As such, a rate field, currency field, institution name field and account number field can be provided as part of the user interface 806.

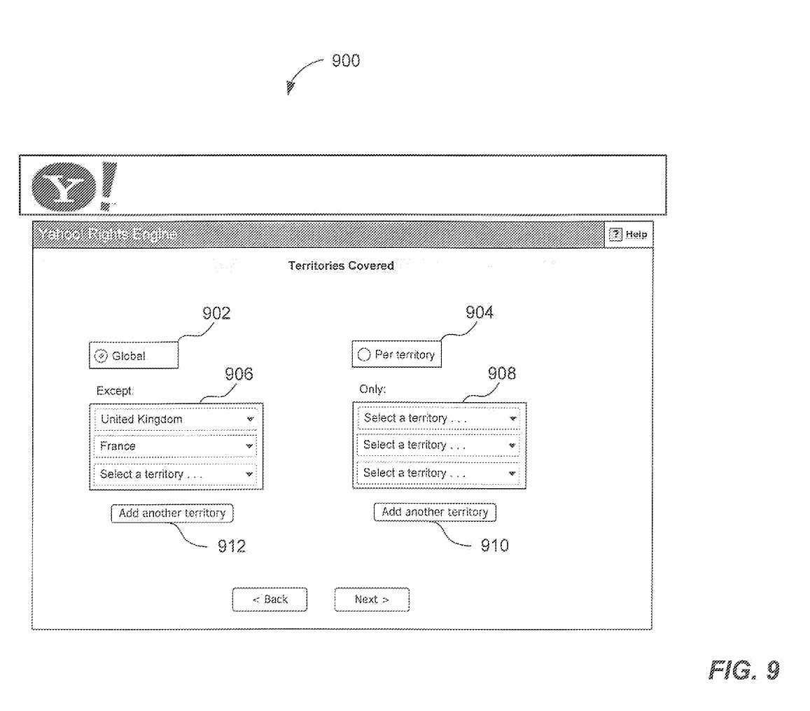

FIG. 9 depicts an example of a user interface for entering permitted territories information related to rights to a content item according to one embodiment. At user interface 900, the rights holder can select whether the distribution of rights or the rights that are being granted for a specific content item or bulk of content items is to be global or very specific territory. In other words, a rights holder can specify the geographical scope of coverage that is provided with the granting of a right or rights associated with the content item. In one embodiment, the rights holder is provided with a radio button 902 and a radio button 904 in order to make a selection of whether the rights are to be made global or per territory. If the rights holder selects radio button 902, the rights are generally assigned globally and further, if the rights holder wants to exclude certain territories, the rights holder can select one or more drop-down menus 906. For example, the rights holder may select to extend specific rights globally except for the United Kingdom and France. In addition, if further territories are to be added, the user interface 900 can provide a button 912 that allows adding additional drop-down menu items 906 so as to enter additional territories that are to be accepted from a global coverage of the license. Furthermore, in another embodiment, the rights holder may select radio button 904 to select specific territories of coverage of the associated rights. Therefore, once the rights holder has selected the radio button 904, additional drop-down menus 908 can be provided for the rights holder to select the territories in which the granted associated rights will be effective. Only in the associated countries or territories provided in drop-down menu 908 will the rights granted be legally utilized. If a rights holder wants to add additional territories to the list of drop-down menus 908, the rights holder may select button 910 to add further drop-down menu boxes to allow the rights holder to select additional territories.

Again territorial limitations can be enforced using various known technologies. In one example, if the IP address of the content consumer is indicative of a corresponding territory that is unauthorized, the content consumer will not be able to receive the content item. Other mechanisms are contemplated for enforcing rights provided to a content consumer. In another embodiment, granted rights do not have to be enforced, and instead, the content consumer can be provided with incentive to maintain the integrity of the granted rights and associated content.

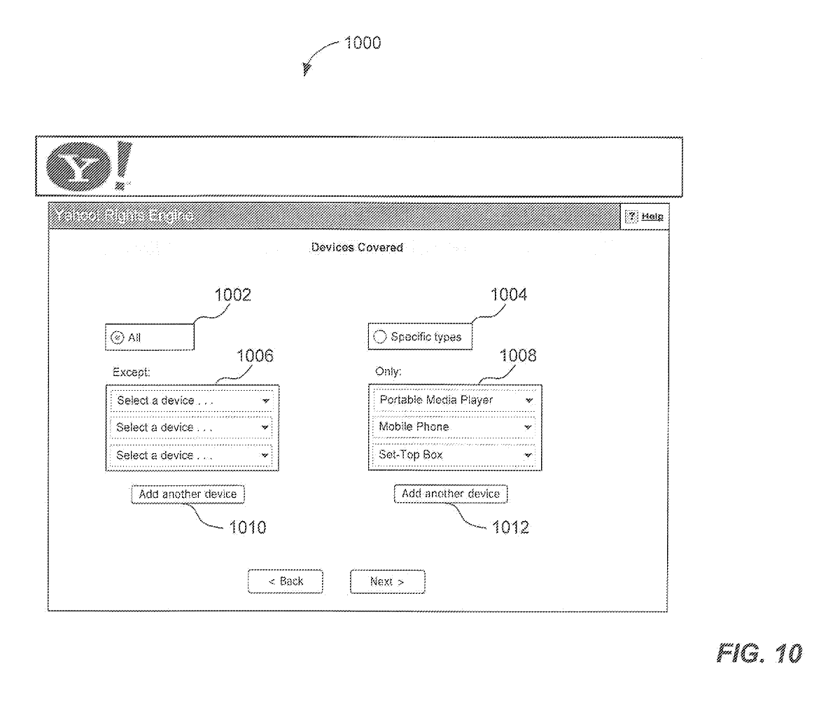

FIG. 10 depicts an example of a user interface for entering permitted devices information related to rights to a content item according to one embodiment. In one embodiment, the rights holder can select one or more devices that can be utilized by a content consumer to render the specific content. The rights holder can, for example, select that all devices are covered and can be legally utilized to render the content items if the rights holder selects a radio button 1002. Additionally, if the rights holder wants to exclude one or more devices from the omnibus inclusion of devices, the rights holder or rights holder may select one of the drop-down menu boxes 1006 to select the devices that are excluded. In one example, the rights holder may select that a portable media player, a mobile phone, and a set-up box are excluded from being rendering devices allowed to play back the content item. Once again, if the rights holder wants to add additional devices to be excluded, the rights holder can select the add button 1010 to add another user interface such as a drop-down menu box 1006 to select another device to be excluded.

In another example, the rights holder may decide to select a specific type radio button 1004. The specific type radio button 104 can permit a rights holder to specify only the devices that are allowed or permitted to render the content items. As such, drop-down menu boxes 1008 can be utilized by the rights holder to indicate which devices are the only devices permitted to render the content item. In addition, button 1012 would permit a rights holder to add additional menu drop-down boxes to allow a rights holder to enter additional devices that will be permitted to play back the content item. As will be understood by one skilled in the art, this configuration of specifying which devices are permitted to play back, and which devices are not permitted to play back the content items can be implemented in other ways.

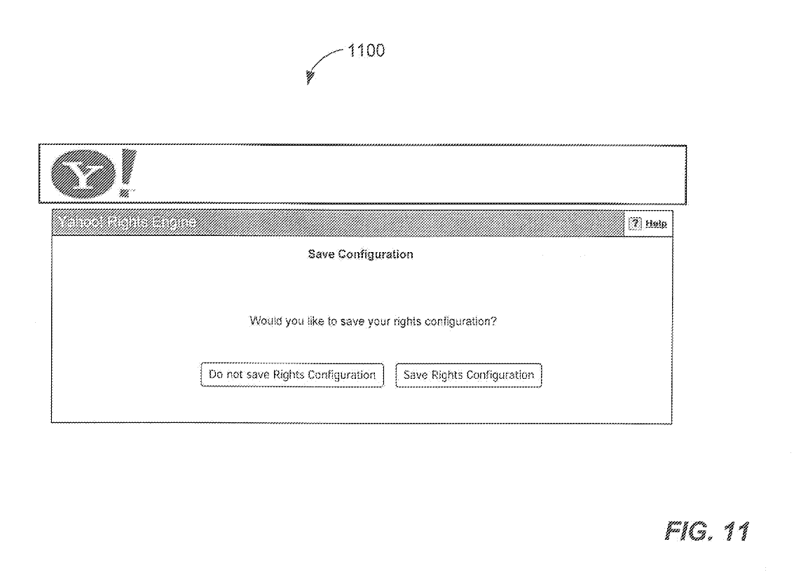

FIG. 11 depicts an example of a user interface for selecting whether a rights configuration is to be saved according to one embodiment. User interface 1100 can be provided to the rights holder to inquire whether or not the rights configuration recently entered by the rights holder should be saved for later use. A cancel button 1102 can be provided for the rights holder in order to permit the rights holder to select that the rights configuration not be saved. In addition, save button 1104 can be provided to the rights holder in order to permit the rights holder to select that the rights configuration be saved as a new bundle of rights. The bundle of rights can include rights delineating coverage of, for example, territories, devices, fee information, and period of license or any other pre-established configuration associated to the rights being granted to the content consumer. As such, once the rights holder saves the bundle of rights, the saved bundle of rights can be accessible to the rights holder so that rights holder can apply the saved bundle of rights to other or new content items.

The bundle of rights configured by the rights holder can be stored in rights database 116 in a canonicalized, computer-readable format to allow computer-implemented processes to process them. In other words, the bundle of rights can define a normalized, computer-readable model of a rights offer, such as a license to use a content item. For example, as discussed below, the bundle of rights can be contained in a data object, such as an XML (or other structured language) document, that may be consumed by a computer-implemented process executed on a host computer. As discussed below, the access rights attributes in the bundle of rights can be searched or crawled by a remote host. In addition, content access layers can be implemented to control access to the content items based on the access rights attributes. Payment modules can access the bundle of rights to compute or estimate revenue payments.

### Rights And Content Access

Once the rights holder has provided content data and access rights attributes to the rights provider 120, the content item and associated rights can be made available to content consumers. Thus, content consumers can utilize a client application residing on the content consumer computing device 106 in order to search content items and associated rights. Search results can be provided to the content consumer in various formats.

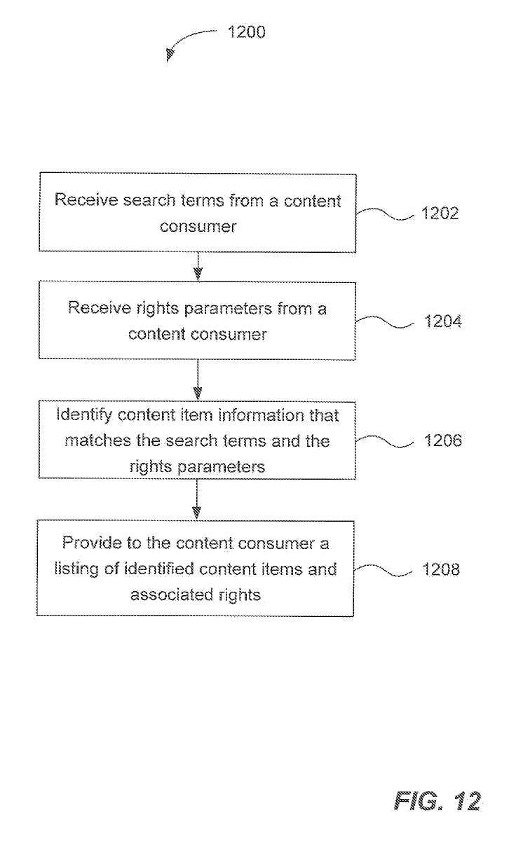

FIG. 12 depicts a flow diagram of an example of a process for searching content items and associated rights according to one embodiment. At process block 1202, search terms are received from a content consumer. Search terms can relate for example to the name of the rights holder, the title of a specific content item the content consumer is looking for, a specific categorization or genre of the content item, etc. The process 1200 continues to process block 1204.

At process block 1204, rights parameters are received from a content consumer. Thus, the content consumer can select the types of rights that the content consumer would like to obtain. Parameters received from the content consumer can include fee information, time limitations, and geographical scope, among others. In one embodiment, a search text box can be provided as part of a user interface. In another embodiment, specialized drop-down menus, radio buttons, etc., can be provided for the content consumer to specific rights parameters desired by the content consumer. The process 1200 continues to process block 1206. In another example, the parameters received can be in the form of an API call.

At process block 1206, content item information that matches the search terms and the rights parameters is identified. As previously discussed, the search module 132 can be configured to cooperate with a rights engine to search for relevant content and rights. The process 1200 continues to process block 1208. At process block 1208, a listing of identified content items and associated rights can be provided to the content consumer. The listing can be in one or more formats. In one embodiment, the listing can be an HTML file that is rendered as a list of content item names and corresponding associated rights. In another embodiment, the listing can be an XML (extensible markup language) file that is fed to a client application in the content consumer 106 device and displayed to the content consumer. Table F below illustrates an XML result file for a search for French rap. Table F shows a source code example of generated XML source code that lists the rights holder information.

```
TABLE F
<?xml version=”1.0”?>
<?xml-stylesheet href=”catalog.xsl” type=”text/xsl”?>
<!DOCTYPE rightsholders SYSTEM “rightsholders,dtd”>
<rightsholders>
    <rightsholder>
        <rightsholder_name>Kaemeleon, Inc.</rightsholder_name>
        <contact_name>John Smith</contact_name>
        <contact_email>jsmith@kameleoninc.com</contact_email>
        <contact_phone>4155551212</contact_phone>
        <physical_address>123 Main Street, San Francisco,
        CA 94123</physical_address>
        <assigned_ID>Y191953</assigned_ID>
        <pay_to_institution>Wells Fargo</pay_to_institution>
        <routing_number>368127849</routing_number>
        <bank_account_number>49820398008-
        </bank_account_number>
        <web_address>www.kameleoninc.com</web_address>
        <rightsholder_tags>new, paris, underground,
        summer</rightsholder_tags>
        <keywords>french, rap, urban, hiphop</keywords>
    </rightsholder>
    <rightsholder>
        <rightsholder_name>Orbitron, Unlimited</rightsholder_name>
        <contact_name>George Melchior</contact_name>
        <contact_email>george@orbitronul.com</contact_email>
        <contact_phone>2125552344</contact_phone>
        <physical_address>55 Pine Street, New York, NY
        10012</physical_address>
        <assigned_ID>Y482947</assigned_ID>
        <pay_to_institution>Chase Manbattan
        Bank</pay_to_institution>
        <routing_number>458127849</routing_number>
        <bank_account_number>79389398008-
        </bank_account_number>
        <web_address>www.orbitroninc.com</web_address>
        <rightsholder_tags>knitting, factory, keren, ann,
        ntm</rightsholder_tags>
        <keywords>french, rap, buddha, trance</keywords>
    </rightsholder>
<rightsholders>
```

In addition, Table G below shows a source code example of generated XML source code that lists the content item information.

TABLE G

```
<?xml version=”1.0”?>
<?xml-stylesheet href=”catalog.xsl” type=”text/xsl”?>
<!DOCTYPE items SYSTEM “items.dtd”>
<items>
    <item>
        <item_name>Royale Deluxe A Cappella</item_name>
        <item_author>Le Mec</item_author>
        <item_description>Paris underground rap from the
        originals.</item_description>
        <item_type>audio</item_type>
        <item_format>256kbps MP3</item_format>
    <item_location>http://kameleoninc.-
    com/royale/royal_deluxe_a_cappella.mp3</item_location>
        <item_ID>Y5552323</item_ID>
        <rightsholder>Y191953</rightsholder>
        <fee_required?>yes</fee_required?>
        <fee_type>flat fee</fee>
        <flat_fee_amount>0.50</flat_fee_amount>
        <currency>USD</currency>
        <territory>global</territory>
        <item_tags>a cappella, paris</item_tags>
        <keywords>french, rap, urban, hiphop</keywords>
    </item>
    <item>
        <item_name>Guerilla Backing Track</item_name>
        <item_author>MC Solaar</item_author>
        <item_description>International beats, recorded in
        Russia.</item_description>
        <item_type>audio</item_type>
        <item_format>256kbps MP3</item_format>
    <item_location>http://orbitronul.com/mcsolaar/guerillaback.-
    mp3</item_location>
        <item_ID>Y1152343</item_ID>
        <rightsholder>Y482947</rightsholder>
        <fee_required?>yes</fee_required?>
        <fee_type>flat fee</fee>
        <flat_fee_amount>0.50</flat_fee_amount>
        <currency>EUR</currency>
        <territory>global</territory>
        <item_tags>a cappella, paris</iitem_tags>
        <keywords>french, rap, edgy, world</keywords>
    </item>
</items>
```

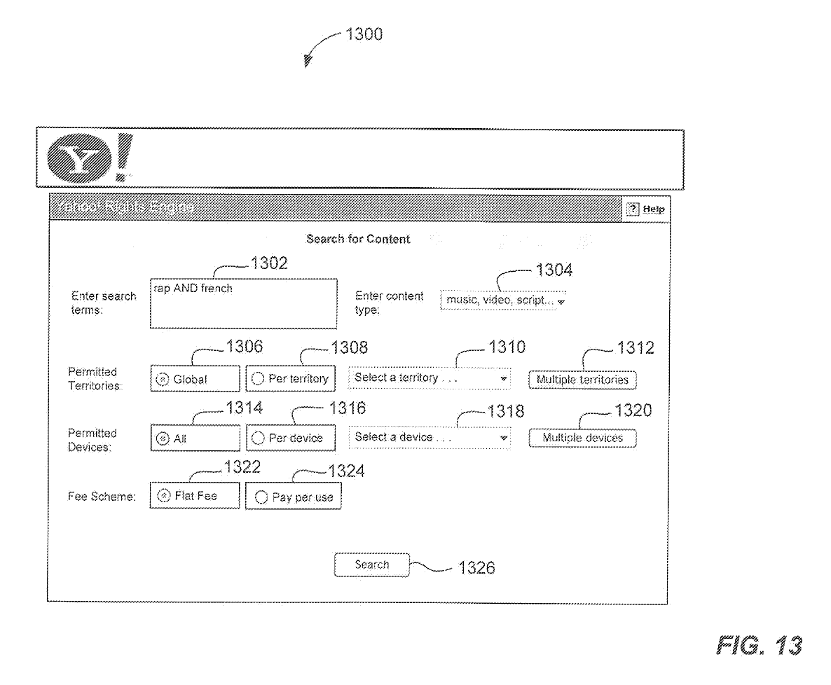

FIG. 13 depicts an example of a user interface for searching content items and associated rights according to one embodiment. User interface 1300 can permit a content consumer to enter one or more search criteria in order to search for content and associated rights. For example a content consumer can be provided with a search textbox 1302 to enter one or more search terms. The search terms entered by the content consumer can then be utilized to perform the search for specific content items. For example, the content consumer can enter the terms “rap” and “French” and the search module 132 can identify in the content database 118 content items that have associated metadata or keywords that include the term “rap” and “French.”

The user interface 1300 can further provide a dropdown menu 1304 that permits the content consumer to enter a content type that the content consumer would like to receive as part of the search results. For example, content type can be music files (e.g. *.mp3, *.mid, *.wav, etc), video files (e.g. *.mpg4, *.avi), images (*.jpg, *.bmp), text documents (e.g., *.doc, *.pdf), scripts, narratives, literary works, software, etc. In another example, the content type can be a patent. In another example the content type can be a trademark.

A radio button 1306 and a radio button 1308 can be provided as part of a user interface 1300 to permit a content consumer to select a global rights license or a per-territory rights license. Thus, for example if the content consumer selects the radio button 1306, the content consumer would be effectively searching for content items that have associated rights that as provided by the rights holder would be global. In another example, if the content consumer selects that radio button 1308 the content consumer would be searching for content items that have associated rights that are granted on a per-territory basis or at least in the territory indicated in the dropdown menu 1310. For example, if the content consumer would like to make sure that the rights granted are in the United Kingdom, the content consumer can select that radio button 1308 and furthermore select a territory 1310 as the United Kingdom. Additionally, if the content consumer would like to select additional territories, the content consumer can select the button 1312.

In another embodiment, the user interface 1300 further provides radio button 1314 and radio button 1316 to select one or more rendering device permitted to render the content items. Thus, for example, if the content consumer selects radio button 1314 the content consumer would be searching for content items that have associated rights that permit the content consumer to utilize all of the devices available to render that content item. In another example, if the content consumer selects the radio button 1316 the content consumer would be selecting to search content items that can be at least played in the device selected in the drop down menu 1318. If the content consumer wants to select additional device, the content consumer can select button 1320 which can then present to the content consumer additional devices for selection.

User interface 1300 can further provide a radio button 1322 and radio button 1324 in order to permit the content consumer to select the fee scheme that the content consumer prefers and is searching for. As such, if the content consumer selects the flat fee ratio button 1322, only content items that are provided on a flat fee basis would be part of the search results. On the other hand, if the content consumer selects the pay-per-use radio button 1324 those content items having a pay-per-use basis scheme would be listed as part of the search results. Finally, a search button 1326 can be provided to the content consumer in order to submit a search.

In further embodiment, the content consumer can submit a search through a client application that receives user interlace input from the content consumer, and generates a source code file that invokes API calls to be received and interpreted by the API module 112. For example, the generated code file can be an XML file that can be parsed and interpreted by the API module as a search request.

### Automated Rights Acquisitions and Transaction Mechanism

In particular implementations, the functionality of rights provider 120 may also be extended to facilitate all or part of transactions directed to acquiring rights in content items. For example, rights provider 120 may include a content consumer database 150 that maintains information for one or more content consumer accounts. Content consumers may access rights provider 120 and provide authentication information to log in to an account. Accordingly, a content consumer, during an active session, can actively transact to acquire rights offered by rights holders. Table H shows an exemplary content consumer record with corresponding fields and a description of the fields. The content consumer record can for example include information related to the content consumer such as the name, contact information, content consumer identifier, payment information, among others. The content consumer database 150 may also include additional information, such as account passwords and digital certificates for purposes of user and/or transaction authentication.

TABLE H
Content Consumer

| Field | Description |
|---|---|
| consumer_name | name of content consumer |
| contact_name | contact name |
| contact_email | email address of contact |
| contact_phone | phone number of contact |
| physical_address | address_of_consumer |
| assigned_ID | a sixteen character ID assigned by system |
| pay_from_institution | bank or other institution name |
| routing_number | bank routing number |
| bank_account_number | bank account number |

As discussed above, rights provider 120 allows content consumers to search for content items. When the content consumer identifies a desired item, rights provider 120 supports work flows that facilitate the acquisition of rights to the content item. For example, in one implementation, a content consumer can activate a control, such as a hypertext link, to initiate a transaction workflow during which the content consumer may assent to the terms defined by the rights holder for the content item. The content consumer may manifest intent to be bound by clicking on an interactive control, such as a hyperlink. In one implementation, an identifier for the content item is associated with the account of the content consumer.

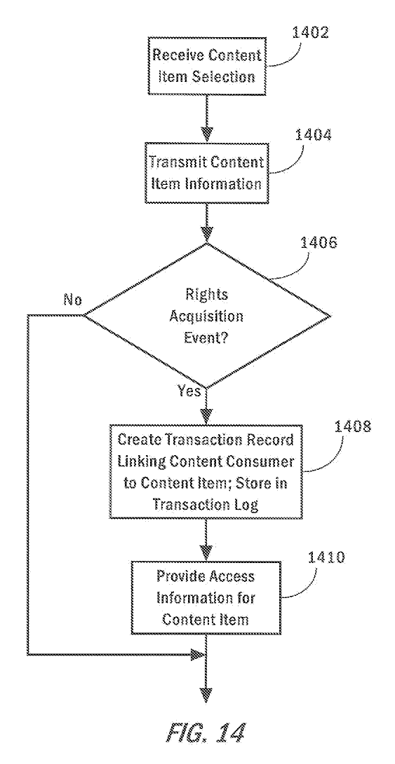

FIG. 14 illustrates a process flow, according to one implementation of the invention, directed to acquiring rights in a given content item. For example, when rights provider 120 receives a selection of a content item (1402), such as from a list of content items returned in search results, it may transmit a page including additional information regarding the content item, such as an expanded view of access rights, additional or alternative payment terms, alternative rights models, related content items, and the like. If the content consumer elects to acquire the rights in the content item (1406), the rights provider 120 creates a transaction record (see below) that links the content consumer's account to the content item (1408) and provide information to the content consumer facilitating access to the content item (1410). For example, the rights provider may provide a data object that embodies the content item. The rights provider may provide one or more data locators for the content item that can be embedded in HTML pages or other data objects, such as Flash objects and the like.

In one implementation, the content consumer may use software to automate or partially automate the acquisition of both consumption and/or re-distribution rights in the content item (1406). The rights provider 120 may treat these automated content acquisition agents as if they were real humans or it could create a specialized API for them, but just like a live human user acquires rights, the rights provider 120 creates a transaction record (see below) that links the content consumer's account represented by the automated agent software to the content item (1408) and provide information to the content consumer's agent facilitating future or immediate access to the content item (1410). For example, the rights provider may provide a data object that embodies the content item. The rights provider may provide one or more data locators for the content item that can be embedded in HTML pages or other data objects, such as Flash objects and the like.

Still further, the transaction may cause rights provider 120 to store a record of the transaction in transaction log 152. Transaction log 152 may map associations between content items and content consumer records as well as content publisher, network provider or other revenue-sharing partner for the content transaction. For example, transaction log 152 may include one or more transaction records that point to a content item and a content consumer record, as well as a content publisher and carrier network records. The transaction records may also include other information, such as transaction time, digitally signed time stamps, revenue-share requirements among others. Information contained in transaction log 152 may also be provided to rights holders, content consumers, content publishers, content distribution network or carrier, third-party audit services, law enforcement, etc. For example, rights holders may access rights provider 120 to determine who has licensed their rights in content items. Content consumers may access rights provider 120 to determine how many licenses they have executed over a given time. Content publishers may access rights provider 120 to determine their expected revenue share or user content consumption trends and networks or carriers may access to manage traffic and accounting.

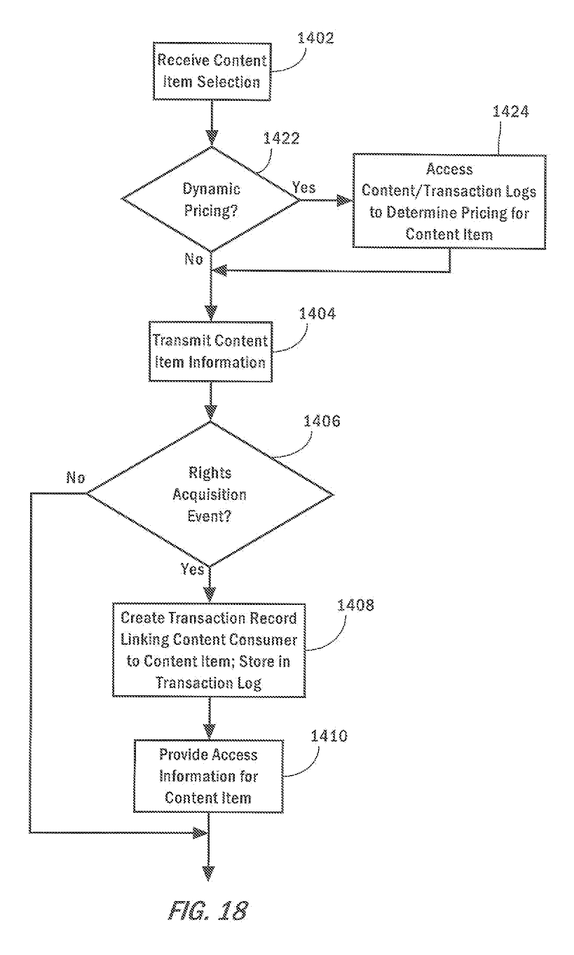

In addition, content consumers may access rights provider 120 to identify how many other content consumers have acquired the same or similar licenses in content items. Furthermore, the transaction logs may also be processed by revenue stream modules to automatically compute payments to rights holders. In addition, information in the transaction logs can also be used to facilitate dynamic pricing of a content item. For example, a rights holder may configure a pricing mechanism where the content item is available at a first price level for the first N content consumers, and a second price level for content consumers who acquire rights in the content item after the first N content consumers. For example, as FIG. 18 illustrates, rights provider 120 may access the transaction and content consumption logs to determine one or more pricing parameters for the content item (1424), if the content item has been configured with one or more dynamic pricing attributes (1422). Likewise, if the content consumer is a content re-seller, the content consumer may also configure a pricing mechanism (based on the discretion in the revenue-sharing arrangement) where the content item is available at a first price level for a certain first period of time, and a second price level for content consumers who acquire rights in the content item after that first period expires.

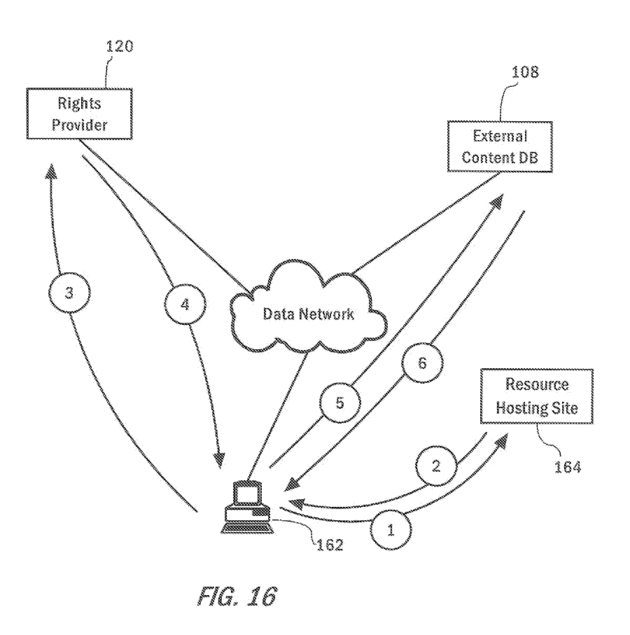

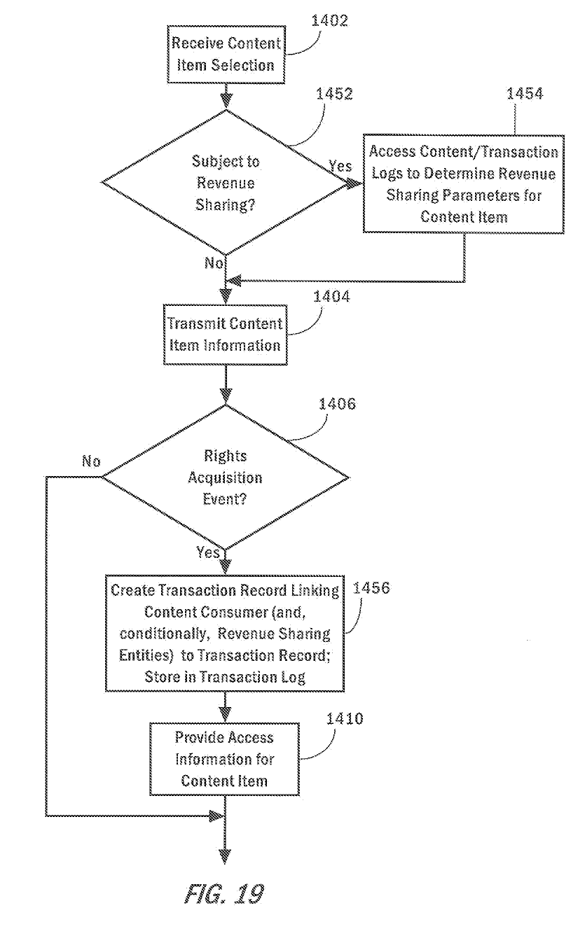

Still further, as FIG. 19 illustrates, rights provider 120 may access the transaction and content consumption logs to determine one or more revenue-sharing parameters for the content item (1454), if the content item has been configured to be subject to any revenue-sharing agreements (1452). If so, transaction records created responsive to rights acquisition events (1406), may cause rights provider 120 to link content consumers and one or more revenue sharing entities to a transaction record (1456). A variety of revenue sharing arrangements can be implemented. For example, if the content consumer is a content publisher, the content publisher and the rights holder may share in advertisement revenue generated from using the content on one or more resource hosting sites 164 (see FIG. 16). In a re-seller model, the content consumer may access acquire rights to re-publish the content item for purposes of re-selling rights to the content item. In such an implementation, a transaction record linking the content consumer and the rights holder to a revenue sharing transaction agreement.

In one implementation, the data locator provided to the content consumer may comprise a redirection URL. For example, the data locator may comprise a host name or IP address corresponding to rights provider 120, and include, as an encoded parameter, a content item identifier and/or a uniform resource locator indicating whether the content item is hosted. The parameter information may also include a content consumer identifier or information mapping to a content consumer identifier, as well as a content publisher/re-seller identifier, information mapping to a content consumer identifier, and/or information mapping to a transaction record. In this implementation, rights provider can track and/or control content usage (where the content is stored remotely from rights provider 120), and redirect requesting client applications to the system hosting, publishing or re-publishing the content. In particular implementations, the functionality of rights provider 120 may also be extended to log one or more events associated with registered content items.

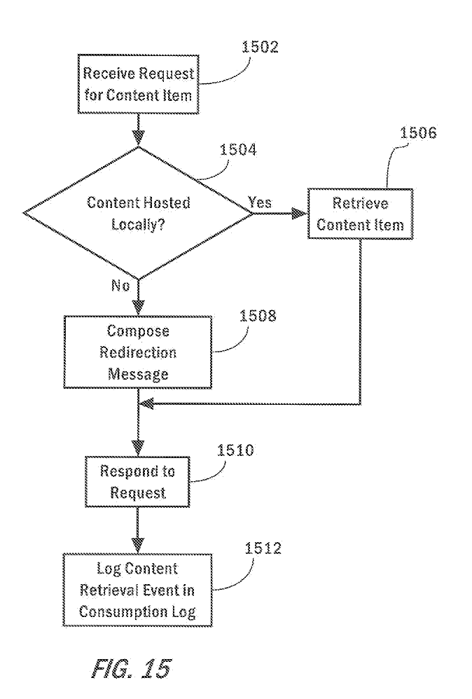

FIG. 15 illustrates a process flow, according to an implementation of the invention, involving processing requests for content items. FIG. 16 illustrates an example message flow that may be initiated in connection with retrieving content. As discussed above, a content consumer, acquiring rights to a given content item, may be provided with content access information, such as a URL and possible other code that can be embedded in underlying resources, such as HTML pages and Flash objects, hosted on a network addressable system 164 of the content consumer or a third party. The data locator itself may include a content item identifier, and/or a an identifier that maps to a transaction in transaction log. In such an embodiment, rights provider 120 may track the end-user accesses that resulted from different rights acquisition and re-seller events to enable revenue tracking and sharing among a variety of entities including rights holders, re-sellers, and the like. Accordingly, end users at client nodes 162 may access the underlying resource (FIG. 16, Ref. No. 1), and receive the underlying resource, such as an HTML page (FIG. 16, Ref. No. 2). In one implementation, the client application, such as a browser, on the client node 162 parses the underlying resource and, as a result of consuming the URL identifying the content item, transmits a request for content to rights provider 120 (FIG. 16, Ref. No. 3).

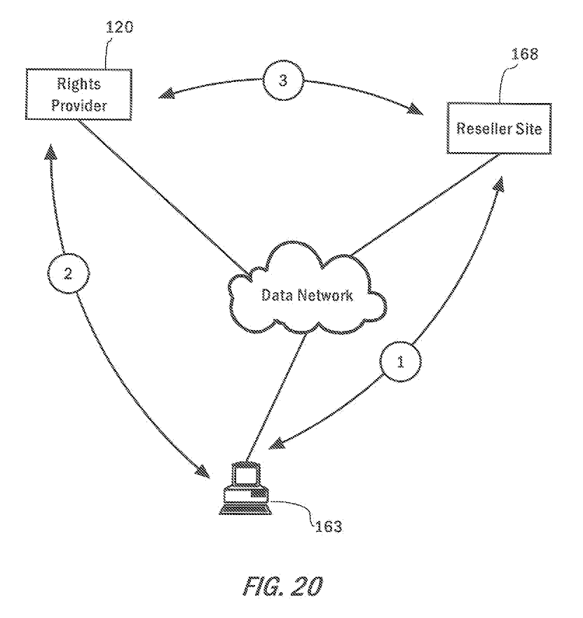

Referring to FIG. 15, when rights provider 120 receives the request identifying the content item, it determines whether the content item is hosted locally in content database 118 or, remotely, in an external content database 108 (1504). If the content is hosted locally, rights provider 120 retrieves the content item from content database 118 (1506), transmits a response to the request (1510; see also FIG. 16, Ref. No. 4), and logs a content retrieval event in a content consumption log 154 (1512). If the content is hosted in an external database, however, rights provider accesses information in the content database 118 to determine the data locator where the content item is hosted, and composes a redirection message to the client node 162 (1508). The redirection message, when processed by the client causes the client node to retrieve the content from the external database 118 that hosts the content (FIG. 16, Ref. No. 5, 6). Other communications flows are also possible. For example, rights provider 120 may retrieve externally hosted content from the external database 118 as a backend operation, and transmit it in a response to the client node 162. Still further, FIG. 20 illustrates a message flow that may be initiated when a content consumer 163 acquires rights from a re-seller. For example, end users at client nodes 163 may access an underlying resource at reseller site, and receive the underlying resource, such as an HTML page (FIG. 20, Ref. No. 1). In one implementation, the client application, such as a browser, on the client node 163 parses the underlying resource and, as a result of consuming the URL identifying the content item, transmits a request for content to rights provider 120 (FIG. 20, Ref. No. 2). The rights provider 120 may provide the content item to client node 163 as discussed above. If the user at client node 163 desires to acquire rights to the content item, reseller site 168 may initiate a session with rights provider 120 to create a transaction record that links the content consumer, the re-seller and the rights holder to the content item.

Information in the content consumption log may be used for a variety of purposes. For example, consumption information, such as the number of end-user accesses of the content item, can be displayed to content consumers to facilitate transaction decisions regarding the content items, such as assessing the popularity of the content items either in aggregate or in segments of the content consumer population based upon demographic, access point, access device, network, etc. Furthermore, the content consumption logs can be used to compute revenue streams for one or more content items based on payment terms and revenue-sharing obligations indicated in the access rights attributes or content publication attributes. Content consumption and transaction logs can also be used to assist auditing processes. Content consumption logs can also be used to facilitate dynamic pricing models where the price or revenue attributable to events corresponding to content items can change depending on observed activity or estimated popularity of a content item as well as dynamic revenue-sharing models where the distribution of the revenue among rights holder, rights provider and any publishers or consumers can change depending on observed activity or content or content consumption attributes. For example, a rights holder may be willing to share more revenue with a rights provider or content publisher for a specific demographic of content consumer.

The rights engine can also allow one piece of media content to participate in multiple digital marketplaces at multiple terms as well as enabling a real-time feedback as to the commercial success of content over time. Because the content as naturally published on a public network is licensable right there at the point of distribution, any license of the content whether viewing, downloading or obtaining re-publication rights, creates an immediate content consumer response action that triggers updating of the content transaction logs. With that licensing data available in substantial real-time, the present invention thereby facilitates a new and valuable data stream for the rights engine or marketplace operator to use to identify high value content early in its lifecycle, thus facilitating a timely and cost-effective means to better exploit the value of these “break away” media content objects. Since rights engine facilitates a local (media object always carries transaction policies with it) as well as a centralized (rights engine operators applications and databases) explicit recitation of transaction policies in a machine-readable form, the content objects in the field can be tracked, coordinated and used themselves as nodes on a network for tracking and facilitating authorized delivery and use as well as policing unauthorized delivery and use.

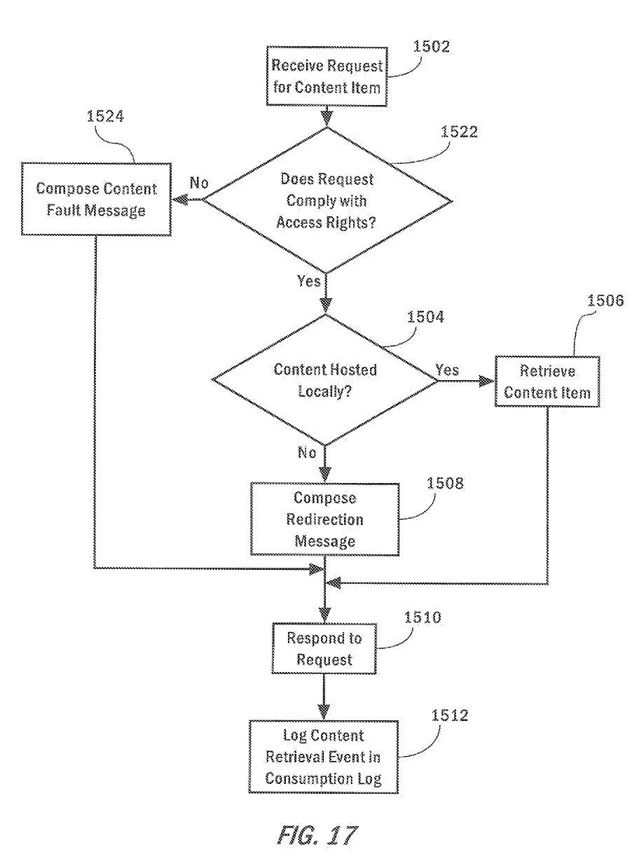

Computer-readable access rights also facilitate enforcement of access rights. In one implementation, rights provider 120 may include an enforcement layer or module that intercepts requests for content, and assesses compliance with one or more access rights associated with the requested content item. For example, as FIG. 17 illustrates, when a request for a content item is received, rights provider 120 may determine whether the request complies with the access rights associated with the content item (1522). If not, rights provider 120 may generate a content fault message (1524) and/or perform additional operations.

Enforcement of access rights, responsive to requests for content, can be accomplished in a variety of manners. For example, territorial restrictions may be enforced by comparing the source IP address of the request with a database that maps IP addresses or address ranges to geographical locations. Likewise, this method is also effective for enforcing network or carrier restrictions. Device restrictions can be enforced, in some implementations, by accessing device and/or client application identifiers in the requests. Time-base restrictions may be enforced by comparing the time the request is received against any time-based restrictions associated with the content item. User-restrictions may be enforced by identity or logon procedures as well as through behavioral targeting models based upon user actions to spot automated (hots, fraud detection, etc.) or otherwise non-compliant requests for access or rights. Compliance assessment may also be performed in an offline manner. For example, pursuant to the terms specified by a rights holder, a content publisher and/or content consumer may agree to provide server logs to rights provider 120, which may process the server logs to assess for compliance with the access rights. These processes may also be automated by the rights provider 120 through their user interface controls provided to rights holder, publishers and consumers.

Those skilled in the art will recognize that the methods and systems of the present disclosure may be implemented in many manners and as such are not to be limited by the foregoing exemplary embodiments and examples. In other words, functional elements being performed by a single or multiple components, in various combinations of hardware and software or firmware, and individual functions, can be distributed among software applications at either the client or server level or both. In this regard, any number of the features of the different embodiments described herein may be combined into single or multiple embodiments, and alternate embodiments having fewer than or more than all of the features herein described are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, and those variations and modifications that may be made to the hardware or software or firmware components described herein as would be understood by those skilled in the art now and hereafter.

1. A method of providing content to consumers, comprising:
receiving from a rights holder either a location indicator indicative of a network address where a content item is located or a content item;
receiving from the rights holder access right attributes to be associated with the content item;
storing the content item or the location indicator in association with the access right attributes; and
providing to a rights consumer a searchable repository via which the rights consumer can access the content item according search parameters that comprise the access right attributes associated with the content item;
receiving indications of content consumption events for the content item; and
storing the indications of content consumption events in a consumption log associated with the content item.

2. The method of claim 1 wherein the consumption log associated with the content item is accessible by the access rights consumer.

3. The method of claim 1 wherein the indications of the content consumption events comprise requests for the content item.

4. The method of claim 1 wherein the access right attributes are stored in a canonical format consumable by a computer-implemented process.

5. The method of claim 1 wherein receiving the indication of the access rights includes receiving a license to use to content item.

6. The method of claim 1, wherein receiving the indication of access rights comprises receiving an indication of a limited period of access.

7. The method of claim 1, wherein receiving the indication of access rights comprises receiving an indication of a geographical limitation.

8. The method of claim 1, wherein receiving the indication of access rights comprises receiving an indication of a rendering device limitation.

9. The method of claim 1, further comprising storing the content item.

10. The method of claim 1, wherein the content item is displayed as a preview user interface that permits a content consumer to preview the content item.

11. The method of claim 1, further comprising dynamically determining a price for the content item based on the consumption events associated with the content item in the content consumption log.

12. A method of providing content to consumers, comprising:
receiving from a rights holder either a location indicator indicative of a network address where a content item is located or a content item;
receiving from the rights holder access right attributes to be associated with the content item;
storing the content item or the location indicator in association with the access right attributes; and
providing to a rights consumer a searchable repository via which the rights consumer can access the content item according search parameters that comprise the access right attributes associated with the content item;
receiving indications of rights acquisition events for the content item; and
storing the indications of rights acquisition events in a transaction log associated with the content item.

13. The method of claim 12 further comprising
providing, responsive to a rights acquisition event, a data locator for the content item to a content consumer.

14. The method of claim 13 wherein the data locator includes an identifier associated with the content consumer.

15. The method of claim 12 wherein the indications of rights acquisition events comprises one or more attributes defining a revenue sharing agreement.

16. The method of claim 12 wherein the transaction log comprises one or more transaction records.

17. The method of claim 16 wherein at least one of the one or more transaction records identifies a rights holder, a content item and a content consumer.

18. The method of claim 16 wherein at least one of the one or more transaction records identifies a rights holder, a content item a content re-seller, and a content consumer.

19. The method of claim 13 wherein the data locator includes an identifier associated with the rights acquisition event.

20. A system of providing content to consumers, comprising:
a rights database for storing an indication of access rights to be associated with the content item, the indication of access rights being received from the rights holder;
a content database for storing a location indicator that is indicative of a network address where the content is located, the location indicator being received from the rights holder;
a content consumption log for storing indications of content consumption events for the content item; and
a transaction log for storing indications of rights acquisition events for the content item; and
a rights engine operative to
provide to a content consumer access to the content item according to search parameters that comprise the indication of access rights associated with the content item;
receive indications of content consumption events for the content item; and
store the indications of content consumption events in the content consumption log.

21. The system of claim 20 wherein the rights engine is further operative to:
receiving indications of rights acquisition events for the content item; and
storing the indications of rights acquisition events in a transaction log associated with the content item.

22. The system of claim 20 wherein the rights engine is further operative to:
receive requests for the content item; and
enforce the access rights for the content item in response to the requests for the content item.

23. The system of claim 22, wherein the indication the access rights includes a license to use to content item.

24. The system of claim 22, wherein the indication of access rights comprises an indication of a limited period of access.

25. The system of claim 22, wherein the indication of access rights comprises an indication of a geographical limitation.

26. (canceled)
